(19) United States
(12) Patent Application Publication
(10) Pub. No.: US 2010/0185955 A1
(43) Pub. Date: Jul. 22, 2010

(54) Image Display Device and Image Display System

(75) Inventors: Masashi Kato, Nagoya-shi (JP); Hirotaka Asakura, Nagoya-shi (JP); Katsuhiro Amano, Toyota-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/748,890

(22) Filed: Mar. 29, 2010

Related U.S. Application Data
(63) Continuation-in-part of application No. PCT/JP2008/067153, filed on Sep. 24, 2008.

(30) Foreign Application Priority Data
Sep. 28, 2007 (JP) 2007-253114

(51) Int. Cl. G06F 3/048

(52) U.S. Cl. 715/751

(57) ABSTRACT

Included are a receiving unit and a screen resolution mediation means. The receiving unit receives window image data as image data of windows on virtual screens and screen resolution signals of the virtual screens from a plurality of computer devices. When it is determined, based on the screen resolution signals received by the receiving unit, that virtual screens of the plurality of computer devices have different resolutions, the screen resolution mediation means sends screen resolution mediation signals for mediating between the screen resolutions of the virtual screens to a plurality of computer devices.

### BACKGROUND OF THE INVENTION

1. Field of the Invention

The present invention relates to an image display device and an image display system capable of displaying windows on virtual screens of a plurality of computer devices on a shared screen as one area.

2. Description of the Related Art

In recent years, in many conferences, participants display data, which has been prepared in advance in their own notebook computers, on an image display device, such as a project. Conventionally, the participants connect the notebook computers to a projector in order, and display thereon the data for their presentations. After the conference ends, each of or someone of the participants adds the decision of or changes made in the conference to the data. It takes much time for the participants to update the data.

It will be very convenient, if information is shared and data is edited at the same time with another in a conference. Specifically, if data prepared by the participants is displayed on a shared screen as one area, the data can be edited with another.

The approach proposed is an image display system 300 shown in FIG. 8. In this image display system 300, a plurality of computer devices PC1 and PC2 are connected to a projector 200. The projector 200 displays overlapped windows W1-1, W1-2, W2-1 and W2-2 on a shared screen. Note that these windows are formed on virtual screens of the plurality of computer devices PC1 and PC2. For example, a user 1 moves the windows W1-2 and W1-1 displayed on a display screen of the computer device PC1 to the right side on the virtual screens, by operating a pointing device. Then, the windows W1-2 and W1-1 are displayed on the shared screen.

Meanwhile, as shown in FIG. 9, the virtual screens of the computer devices PC1 and PC2 connected to the projector 300 may have different screen resolutions. In this case, a non-operable area is included on the shared screen of the computer device PC1 including a virtual screen with low screen resolution. In FIG. 9, the user of the PC 1 cannot operate the window on the shared screen (window on the virtual screen of the PC2). Different screen resolutions are caused in the virtual screens of the computer devices, because the settings of the screen resolutions of the virtual screens connected to the projector 200 in the previous connection are retained in the computer devices PC1 and PC2 as they are. As a result, the screen resolutions of the virtual screens of the computer devices PC1 and PC2 connected to the projector 200 differ from each other. Another reason might be that, to largely display an image on the shared screen, the screen resolution of either one of the computer devices PC1 and PC2 is decreased on purpose, and this screen resolution of the virtual screen is retained in the computer devices PC1 and PC2 as is.

### BRIEF SUMMARY OF THE INVENTION

The present invention has been made in view of the problems above, and the invention provides an image display device and an image display system capable of displaying windows on virtual screens on a shared screen of an image display device, and automatically mediating between screen resolutions of the virtual screens of computer devices when the virtual screens of the computer devices have different screen resolutions.

In order to solve the problems above, according to the present invention, there is provided an image display device for displaying windows on virtual screens adjacently provided to display screens of a plurality of computer devices on a shared screen as one area, thereby enabling users of the plurality of computer devices to operate the windows displayed on the shared screen, the device comprising:

a receiving unit which receives window image data as image data of the windows on the virtual screens and screen resolution signals of the virtual screens, from the plurality of computer devices;

an image arrangement means which generates windows from the received window image data, and arranges to overlap the windows on the shared screen; and

a screen resolution mediation means which, when it is determined, based on the screen resolution signals received by the receiving unit, that screen resolutions of the virtual screens of the plurality of computer devices differ from each other, sends a screen resolution mediation signal for mediating between the screen resolutions of the virtual screens to the plurality of computer devices, wherein

the computer devices receive the mediation signal so as to mediate between the resolutions of the virtual screens.

### BRIEF DESCRIPTION OF THE DRAWINGS

FIG. 1 is an explanatory diagram schematically showing a system;

FIG. 2 is a block diagram of an image display device;

FIG. 3 is an explanatory diagram showing a network;

FIG. 4 is a block diagram of a computer device;

FIG. 5 is a flow diagram of the main process according to a first embodiment;

FIG. 6 is an explanatory diagram of a second embodiment;

FIG. 7 is a flow diagram of the main process according to the second embodiment;

FIG. 8 is an explanatory diagram of a conventional image display system; and

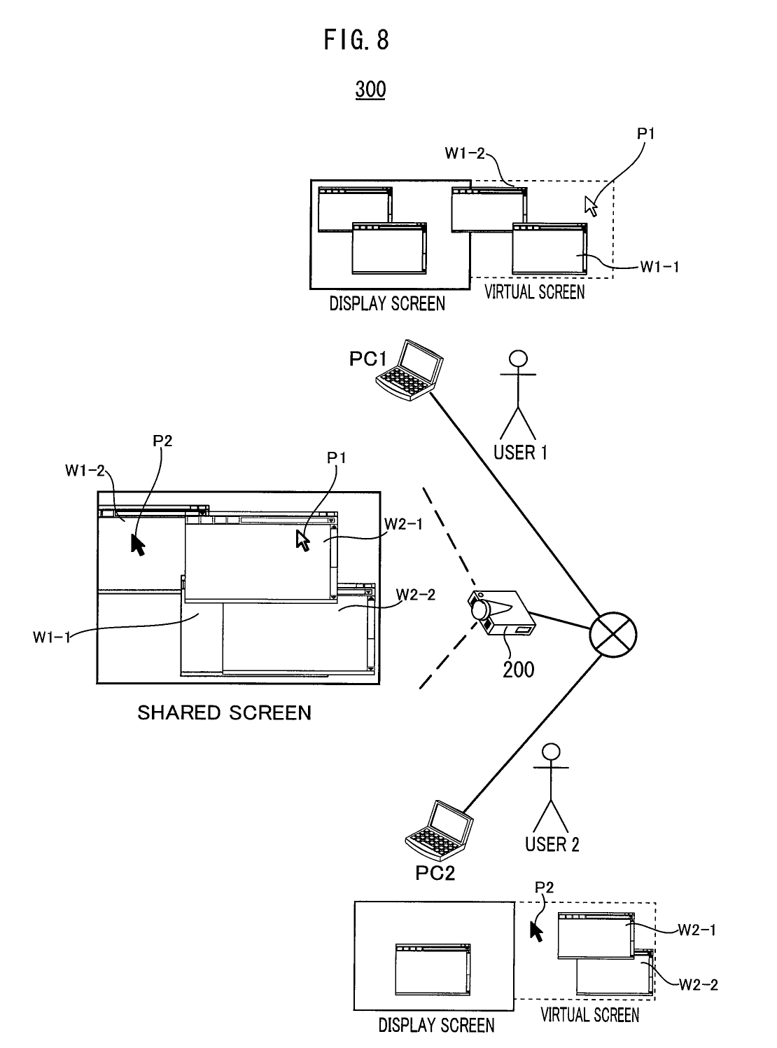

FIG. 9 is an explanatory diagram showing a problem of the conventional image display system.

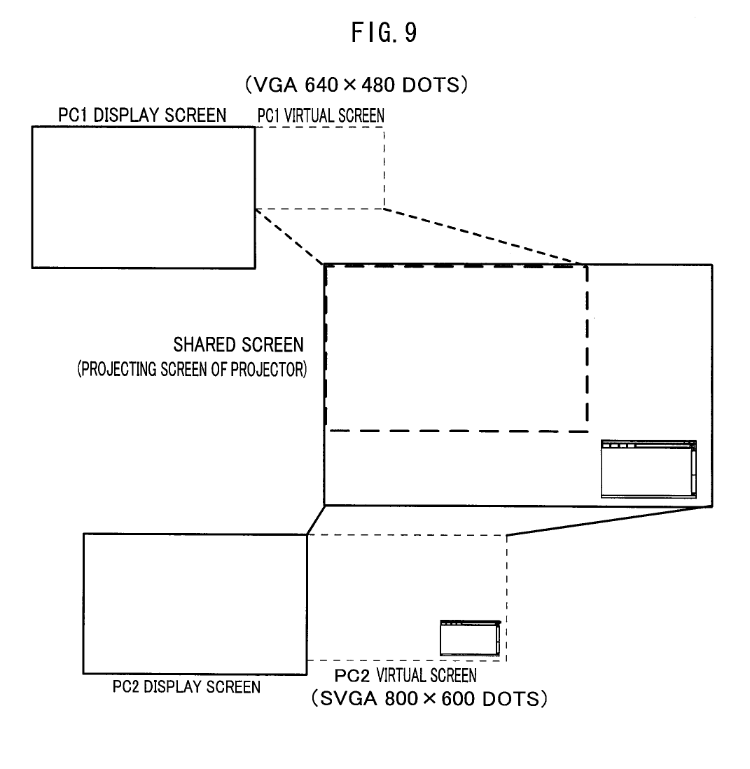

### DETAILED DESCRIPTION OF THE INVENTION

### Schema of Image Display System

Preferred embodiments of the present invention will now be described with reference to the accompanying drawings.

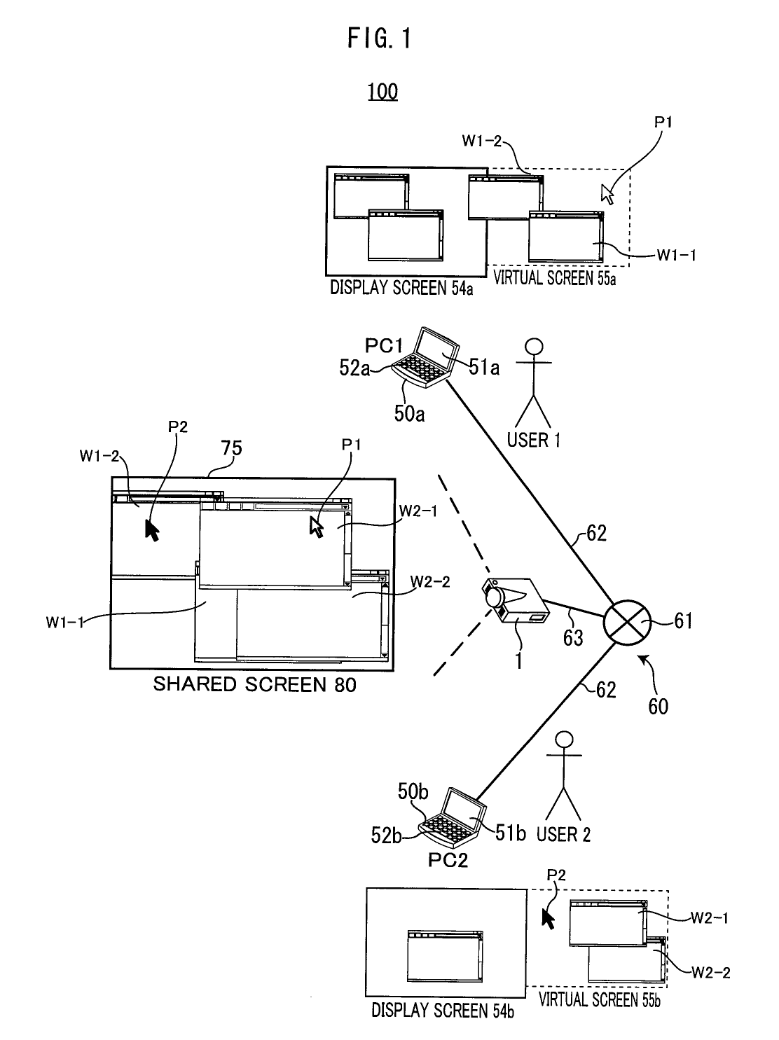

As shown in FIG. 1, an image display system 100 of the present invention can overlap “windows” displayed on virtual screens 55a and 55b of respective computer devices 50a and 50b in one area and display the area as a shared screen 80. Users of the computer devices 50a and 50b can operate the “windows” displayed on the shared screen 80. In FIG. 1, the computer devices 50a and 50b are denoted respectively by PC1 and PC2. In FIG. 1, display screens 54a and 54b are displayed by image display devices 51a and 51b of the respective computer devices 50a and 50b. The virtual screens 55a and 55b are virtual screens of the computer devices 50a and 50b. In FIG. 1, the virtual screens 55a and 55b are virtually provided respectively to the display screens 54a and 54b in an adjacent manner. The virtual screens 55a and 55b are provided virtually in such a manner that the virtual screens 55a and 55b include at least a part that continuous to the display screens 54a and 54b. As will be described later, cursors P1 and P2 and the “windows” can move between the display screens 54a and 54b and the virtual screens 55a and 55b. In this embodiment, the virtual screens 55a and 55b are provided on the immediate right of the respective display screens 54a and 54b. The “windows” include not only a display area for various types of application software, but also a display area for displaying the contents of a corresponding “folder” when this “folder” is opened.

The image display system 100 includes a plurality of computer devices 50a and 50b, an image display device 1 and a communication means 60. The communication means 60 connects the plurality of computer devices 50a and 50b and the image display device 1 for data communication. In this embodiment, the image display device 1 is a projector. The image display device 1 projects a shared screen 80 on a screen 75 or the like.

The number of computer devices 50a and 50b that send data to the image display device 1 is not limited to two, as shown in FIG. 1, and may be three or more. Descriptions will now be made of an embodiment wherein the two computer devices 50a and 50b send image data to the image display device 1.

The computer devices 50a and 50b may be any device that can display the “windows” on the display screens 54a and 54b. For example, the computer devices may be any personal computer, PDA (Personal Digital Assistant), workstation, large general-purpose computer, or the like, using an operating system. The operating system includes Windows (registered trademark), Macintosh (registered trademark), Linux (registered trademark), and MS-DOS (registered trademark).

Each of the computer devices 50a and 50b includes a function for externally outputting “window image data” (image data of the “windows” on the virtual screens 55a and 55b) and “window coordinate data” (data about the position and/or size of the “window”). According to the present invention, the computer devices 50a and 50b send the “window image data” and the “window coordinate data” to the image display device 1 through the communication means 60. The “window coordinate data” includes coordinate information of the “window” on the virtual screens 55a and 55b and also information representing the width and height of the “window”. In this embodiment, the coordinate information of the “window” includes the left upper position of the “window” as a reference point. Each of the computer devices 50a and 50b includes a function for externally outputting a “screen resolution signal” as a signal representing the screen resolution of the respective virtual screens 55a and 55b. The computer devices 50a and 50b send the “screen resolution signal” to the image display device 1 through the communication means 60.

The image display device 1 includes a function for receiving the “window image data”, the “window coordinate data” and the “screen resolution signal” from the computer devices 50a and 50b that are connected through the communication means 60. The image display device 1 includes a function for generating the “windows” based on the received “window image data” and the “window coordinate data”, arranging and overlapping the “windows” in one area, and displaying the area as the shared screen 80.

Each of the computer devices 50a and 50b includes a built-in track-pad or the like as one example (type) of the pointing device, and is connected with the mouse or the like. When a user operates the pointing device, the computer device 50a or 50b generates the pointers P1 or P2 based on a “pointing device signal” acquired upon user operation therefor, and executes a process for displaying the pointers P1 or P2 on the display screens 54a and 54b. The “pointing device signal” includes “cursor position information data”, “pointing device pressing signal” and the like. The “cursor position information data” is parameter data that can be expressed by an “x-coordinate” and a “y-coordinate”, such as (Xp, Yp). Such x-coordinate and y-coordinate data two-dimensionally represent the positions of the cursors P1 and P2. When the user moves the pointing device vertically and horizontally, an x-coordinate parameter and y-coordinate parameter of the “cursor position information data” are supposed to increase or decrease and be modified. The “pointing device pressing signal” is output, when the user presses a button of the pointing device, and includes a signal of “click” and a signal of “drag”. The “click” signal is generated when the corresponding button pressed is quickly released, while the “drag” signal is generated when the pointing device is moved during a time period since the button is pressed until released. The pointing device is not limited to the track-pad or the mouse, and may be any pointing device, such as a track ball, a pointing stick, a pen tablet, and the like. When the cursors P1 and P2 are operated using keyboards 52a and 52b of the respective computer devices 50a and 50b, such keyboards 52a and 52b may be the pointing devices.

Each of the computer devices 50a and 50b includes a function for sending the “cursor position information data” and the “pointing device pressing signal” on the virtual screens 55a and 55b to the image display device 1 through the communication means 60. Each of the computer devices 50a and 50b further includes a function for sending a “keyboard signal” as an operation signal of the keyboards 52a and 52b to the image display device 1 through the communication means 60.

The image display device 1 includes a function for receiving the “pointing device signal” or the “keyboard signal” from the computer devices 50a and 50b that are connected through the communication means 60. The image display device 1 includes a function for displaying the cursors P1 and P2 on the shared screen 80, based on the received “cursor position information data”.

According to the present invention, when the cursors P1 or P2 are moved from the display screens 54a or 54b to the virtual screens 55a or 54b by users 1 or 2 operating the pointing device, the cursors P1 or P2 disappear from the display screens 54a and 54b, and are displayed on the shared screen 80 simultaneously. For example, in FIG. 1, the user 1 moves the cursor P1 displayed on the display screen 54a to the right side by operating the pointing device. When the cursor P1 goes beyond the boundary between the display screen 54a and the virtual screen 55a, the cursor P1 disappears from the right end side of the display screen 54a, and the cursor P1 simultaneously appears from the left end side of the shared screen 80.

The users 1 and 2 can move, click or drag the “window” on the shared screen 80 by operating the pointing device. For example, the user 1 of the computer device 50a moves the window W1-1 displayed to the right side on the display screen 54a by dragging it. When the window W1-1 goes beyond the boundary between the display screen 54a and the virtual screen 55a, a part of the window W1-1 that goes beyond, the boundary appears and is displayed from the left side of the shared screen 80.

The image display device 1 includes a function for identifying either one of the computer devices 50a and 50b which sends the “window image data” of the “window” pointed by the cursor P1 and P2 on the shared screen 80 and sending the “pointing device signal” or the “keyboard signal” to the identified computer device 50a or 50b.

Each of the computer devices 50a and 50b includes a function for receiving the “pointing device signal” or the “keyboard signal” of the other computer device 50a or 50b from the image display device 1 and transferring it to the operating system or application software of the computer device 50a or 50b.

According to this configuration, the user 1 can operate a window W2-1 on the virtual screen 55b of the computer device 50b, if the image display device 1 sends, for example, the “pointing device signal” or the “keyboard signal” to the computer device 50b that outputs the “window image data” of the window W2-1 pointed by the cursor P1.

As a result, the user 1 operates the computer device 50a while watching the shared screen 80 displayed by the image display device 1, thereby enabling direct editing of the window W2-1 without orally instructing the user 2 to edit the window.

The user 1 operates the window W2-1 displayed on the shared screen 80 by operating the pointing device of the computer device 50a. In this case, the image display device 1 outputs the “pointing device signal” or the “keyboard signal” output from the computer device 50a to the computer device 50b. The computer device 50b transfers this “pointing device signal” or the “keyboard signal” to the “operating system” or the “application software” that displays the window W2-1. This “operating system” or “application software” performs processing based on the “pointing device signal” or the “keyboard signal”. For example, if the window W2-1 is a “window” of a word processor, the user 1 can move the cursor P1 to a desired position of the window W2-1 by operating the pointing device of the computer device 50a, and can also input characters in the window W2-1 by operating the keyboard 52a of the computer device 50a. Accordingly, the computer device 50b acquires the “pointing device signal” or the “keyboard signal” output from the computer device 50a through the image display device 1, and transfers the acquired signal to the word processor software. This word processor software performs various processing, such as inputting of characters or the like, based on the “pointing device signal” or the “keyboard signal”. The “application software” includes business software, such as spreadsheet software, e-mail software, presentation software, in addition to the word processor software, and also includes image processing software, etc. The users 1 and 2 can work together, by operating the “windows” of various software that are displayed on the shared screen 80.

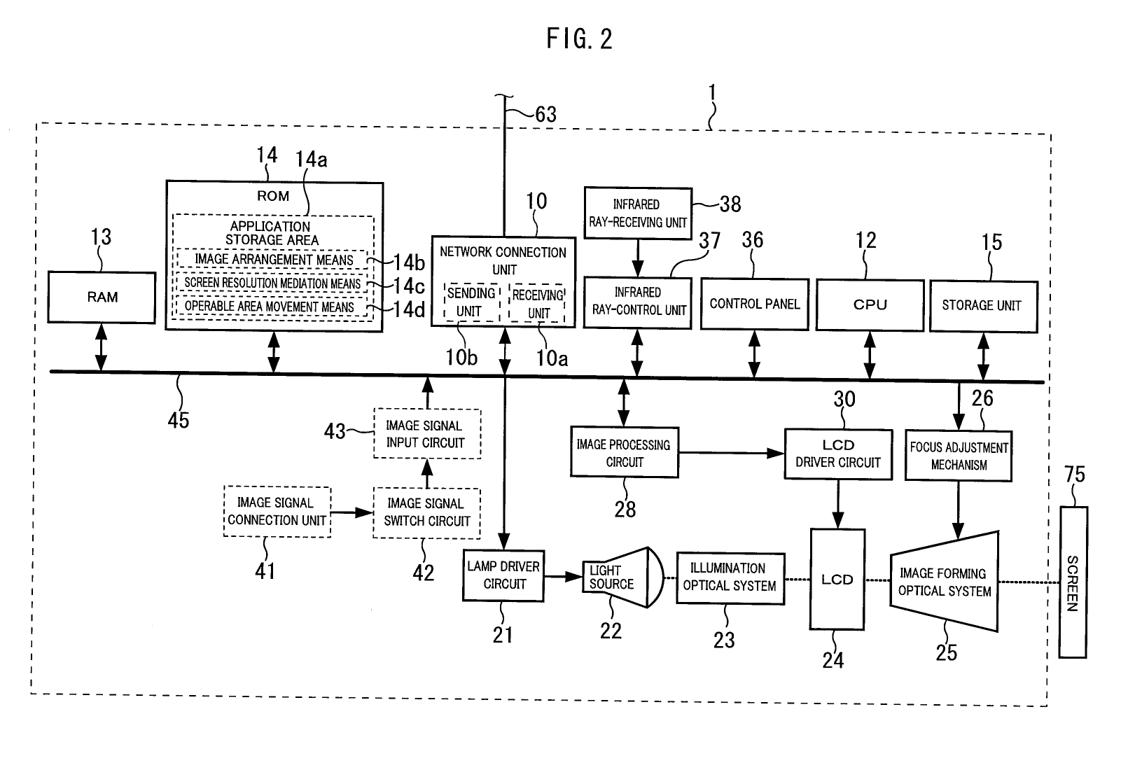

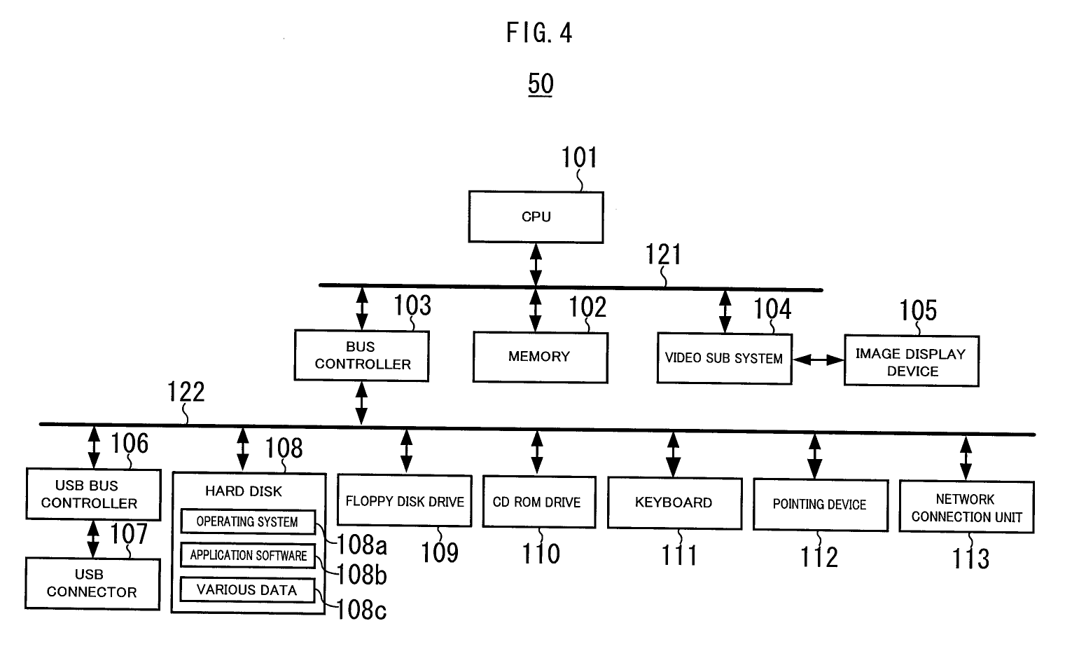

Descriptions will now be made to the communication means 60. The communication means 60 includes, for example, a hub 61, communication lines 62 and a communication line 63 as shown in FIG. 1. The hub 61 connects a plurality of communication lines. The communication lines 62 connect the hub 61 with the plurality of computer devices 50a and 50b. The communication line 63 connects the hub 61 with the image display device 1. The communication line 63 is connected to a network connection unit 10 of the image display device 1 shown in FIG. 2. The communication line 62 is connected with a network connection unit 113 of the computer devices 50a and 50b shown in FIG. 4.

An interface of the network connection unit 10 of the image display device 1 and the network connection unit 113 of the computer devices 50a and 50b may include a LAN (Local Area Network), a USB (Universal Serial Bus), IEEE1394, RS232, RS422, and any other communication interface. The communication lines 62 and 63 are compatible with these interfaces.

Alternatively, the communication means 60 may be a wireless communication means. In this case, the interface may include a wireless LAN specified by IEEE802, Bluetooth and any other wireless interface. In this case, the wireless interface is used as the network connection unit 113 of the computer devices 50a and 50b and the network connection unit 10 of the image display device 1.

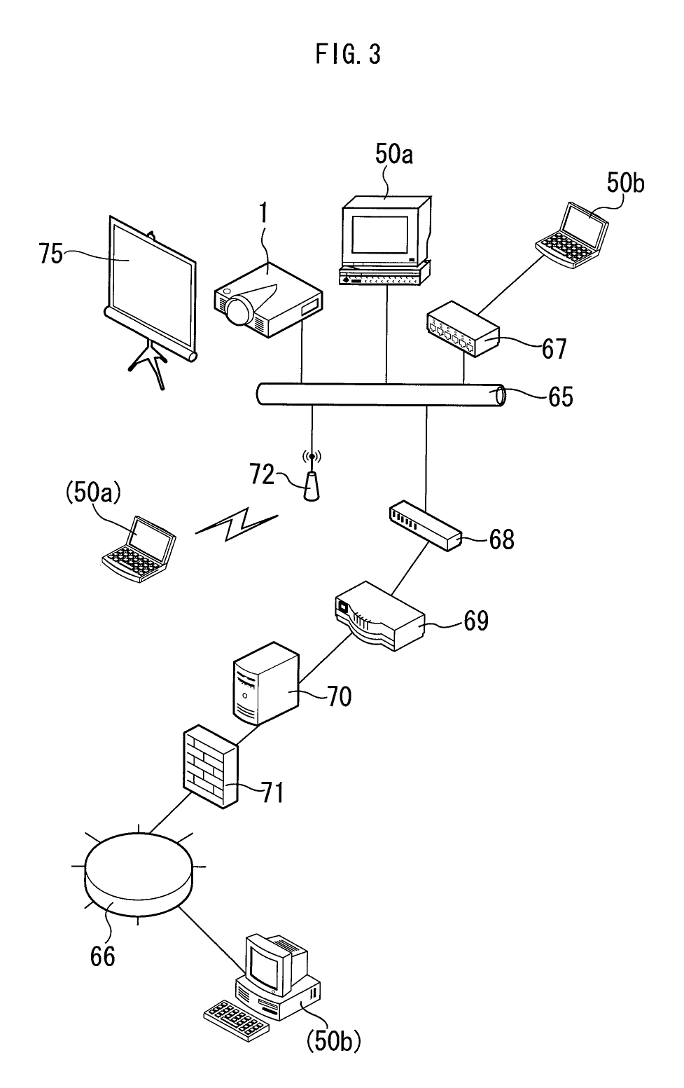

The communication means 60 shown in FIG. 1 may include a so-called intranet 65 or internet 66, as shown in FIG. 3. The computer devices 50a and 50b connected to the network such as Intranet 65 or Internet 66 may be implemented as a type that sends the “window image data”, the “window coordinate data”, the “pointing device signal” and the “keyboard signal” to the image display device 1. In FIG. 3, reference numeral 65 denotes the intranet, 66 denotes internet, 67 denotes a hub, 68 denotes a switch, 69 denotes a router, 70 denotes a server, 71 denotes a firewall, and 72 denotes an access point of a wireless LAN.

### (Description of Configuration of Image Display Device)

Descriptions will now be made to the configuration of the image display device 1. As shown in FIG. 2, the image display device 1 mainly includes the network connection unit 10, a CPU 12, a RAM 13, a ROM 14, a storage unit 15, a control panel 36, an infrared ray-control unit 37, a lamp driver circuit 21, an image processing circuit 28 and a focus adjustment mechanism 26 and the like. These components are connected with each other through a bus 45.

The network connection unit 10 is connected with the communication line 63 of the communication means 60. The network connection unit 10 serves as a receiving unit 10a which receives “window image data”, “window coordinate data”, a “pointing device signal”, a “keyboard signal”, and a “screen resolution signal” of the virtual screen 55 of the computer device 50. These data are sent from the computer devices 50a and 50b. The network connection unit 10 serves also as a sending unit 10b which externally sends various data. Specifically, the sending unit 10b sends data, such as the “pointing device signal”, the “keyboard signal”, a “screen resolution mediation signal” and an “operable area movement signal”, as will be described later, to the computer devices 50a and 50b.

The CPU (Central Processing Unit) 12 performs various calculations and processing in cooperation with the RAM (Random Access Memory) 13 and the ROM (Read Only Memory) 14.

The RAM 13 temporarily stores data to be processed by the CPU 12. The RAM 13 serves as a VRAM (Video RAM) which temporarily stores “shared screen image data” to be displayed on the display screen 80. The VRAM that temporarily stores the “shared screen image data” displayed on the display screen 80 may be separated from the RAM 13, and may be provided separately from the bus 45.

The ROM 14 stores various programs and/or parameters for controlling the image display device 1. An application storage area 14 stores application software for controlling the image display device 1 of the present invention. This application software is processed by the CPU 12 so as to realize various functions. The application storage area 14a of the ROM 14 stores an image arrangement means 14b, a screen resolution mediation means 14c and an operable area movement means 14d.

The image arrangement means 14b generates “windows” with the “window image data” and “window coordinate data” received by the receiving unit 10a, and arranges and overlaps the “windows” in one area, to thereby generate “shared screen image data” to be displayed on the shared screen 80 and output the generated data to the RAM 13.

When it is determined, based on the “screen resolution signal” received by the receiving unit 10a, that the virtual screens 55a and 55b of the computer devices 50a and 50b have different screen resolutions, the screen resolution mediation means 14c generates a “screen resolution mediation signal” for mediating between the screen resolutions of the virtual screens 55a and 55b. The screen resolution mediation means 14c sends the generated signal to the computer devices 50a and 50b through the sending unit 10b. According to the present invention, “to mediate between the screen resolutions” of the virtual screens 55a and 55b is meant to equalize the different screen resolutions of the virtual screens 55a and 55b.

The screen resolutions of the virtual screens 55 of the computer devices 50 may not be mediated upon transmission of the “screen resolution mediation signal” to the computer devices 50 by the screen resolution mediation means 14c. In this case, the operable area movement means 14d moves an “operable area” on the shared screen 80, based on the “operable area movement signal” generated in response to a user operation of the computer device 50 with an area that cannot be operated on the shared screen 80.

The storage unit 15 is an auxiliary memory device, such as a non-volatile memory, a hard disk, etc. The storage unit 15 is to store various settings of the image display device 1. The storage unit 15 may store the “window image data” or “window coordinate data” received by the receiving unit 10a, after its paging is created.

The image display device 1 includes a light source 22, an illumination optical system 23, an LCD 24 and an image forming optical system 25. The light source 22 includes a lamp or the like that emits light with electric power supplied from the lamp driver circuit 21. The illumination optical system 23 condenses diffusion light emitted by the light source 22, and irradiates illumination light on the LCD (Liquid Crystal Display) 24 with more uniform brightness. The LCD 24 inputs the illumination light, and expresses the gradation on each pixel so as to generate an image. The image forming optical system 25 projects the image generated by the LCD 24 on the screen 75 or the like. The LCD 24 may be substituted by a DMD (Digital Micromirror Device). The image forming optical system 25 is formed from a plurality of lenses, and is automatically focused by the focus adjustment mechanism 26. The illumination light transmitted through the LCD 24 is formed on the screen 75 or the like.

The image display device 1 includes an image signal connection unit 41, an image signal switch circuit 42 and an image signal input circuit 43. The image signal connection unit 41 acquires an “image signal” from the computer devices 50a and 50b, and includes a VGA (Video Graphics Array) terminal, a DVI-D terminal or the like. According to the present invention, the receiving unit 10a of the network connection unit 10 receives the “window image data” sent from the computer devices 50a and 50b. Thus, the image display device 1 of the present invention does not necessarily include the image signal connector 41, the image signal switch circuit 42 and the image signal input circuit 43.

The image processing circuit 28 acquires the “shared screen image data” stored in the RAM 13 through the bus 45. The image processing circuit 28 performs image processing, such as sharpness correction, gamma correction, contrast correction, white balance correction, trapezoid correction, etc., as required, and outputs data to an LCD driver circuit 30. The LCD driver circuit 30 outputs a signal electrode drive signal applied to signal electrodes of the LCD 24 and a scan electrode drive signal applied to a scan electrode, based on the “shared screen image data” output by the image processing circuit 28. The LCD 24 generates an image based on the signal electrode drive signal and the scan electrode drive signal acquired from the LCD drive circuit 30.

The control panel 36 changes various settings of the image display device 1, and operates the image display device 1. If the user operates the control panel 36, a setting change signal or an operation signal is transferred to various programs through the bus 45. The infrared ray-control unit 37 acquires the change signal or operation signal for various settings upon user operation by means of a remote controller (not illustrated), through an infrared ray-receiving unit 38. The change signal or the operation signal acquired by the infrared ray-control unit 37 is transferred to various programs through the bus 45.

### (Description of Configuration of Computer Device)

Description will now be made to the computer device 50 with reference to FIG. 4 illustrating a block diagram of the computer device 50. The computer device 50 mainly includes a CPU 101, a memory 102, a bus controller 103, a video sub system 104, an image display device 105, a USB bus controller 106, a USB connector 107, a hard disk 108, a floppy disk drive 109, a CD ROM drive 110, a keyboard 111, a pointing device 112 and a network connection unit 113.

The CPU 101, the memory 102 and the video sub system 104 are connected with each other through a high-speed bus 121. The CPU 101 performs various calculations and processings in cooperation with the memory 102. The memory 102 includes a ROM or a RAM. The ROM stores the BIOS (Basic Input/Output System). The RAM temporarily stores various programs or data loaded from the hard disk 108, and temporarily stores a result of the processing of the CPU 101.

The video sub system 104 generates “display image data” as image data to be displayed on the display screens 54a and 54b, and outputs the generated data to the image display device 105. The video sub system 104 includes a GPU (Graphics Processing Unit) or a VRAM. The GPU generates the “display image data” as aggregated data of pixels, and outputs the generated data to the VRAM, in response to an instruction of the CPU 101. The VRAM temporarily stores the “display image data” generated by the GPU. The “display image data” stored in the VRAM is to be output to the image display device 105.

The video sub system 104 includes a function for generating the “window image data” as image data of the “window” on the virtual screens 55a and 55b and outputting the generated data to the image display device 1 through the communication means 60. The GPU generates the “window image data” as aggregated data of pixels, and outputs the generated data to the VRAM, in response to an instruction of the CPU 101. The VRAM temporarily stores the “window image data” generated by the GPU. The “window image data” stored in the VRAM is to be sent to the image display device 1 from the network connection unit 113 through the communication means 60.

Instead of the VRAM, the memory 102 may temporarily store the “display screen data” or the “window image data”.

The image display device 105 includes an LCD or a CRT (Cathode Ray Tube), etc. The image display device 105 is connected with the video sub system 104, and displays the “display image data” generated by the video sub system 104. According to the present invention, the image display device 105 (51a, 51b) displays only the display screen 54a and 54b, and does not display the virtual screen 55a, 55b.

The bus controller 103 connects the high-speed bus 121 and a low-speed bus 122, and controls data transferred between the high-speed bus 121 and the low-speed bus 122.

The USB bus controller 106, the hard disk 108, the floppy disk drive 109, the CD ROM drive 110, the keyboard 111, the pointing device 112 and the network connection unit 113 are connected with each other through the low-speed bus 122.

The USB connector 107 is to be connected to the USB terminal. The USB bus controller 106 controls data input to the USB connector 107, and outputs the data to the low-speed bus 122.

The hard disk 108 stores an operating system 108a or an application software 108b of the computer device 50, and stores also various data 108c. The application software 108b includes driver software, a program for generating the virtual screens 55a and 55b, a program for changing the screen resolutions of the virtual screens 55a and 55b, and a program for sending a generated signal to the image display device 1. Specifically, the driver software is to connect the image display device 1 and the computer devices 50a and 50b. The program for changing the screen resolutions is to change the resolutions based on a “screen resolution mediation signal” sent by a screen resolution mediation means 10c of the image display device 1. The program for sending the generated signal is to generate an “operable area movement signal” (described later), and to send the signal from the sending unit 10b to the image display device 1 through the communication means 60.

The floppy disk drive 109 is a unit for reading data stored in a floppy disk and writing data on a floppy disk. The CD ROM drive 110 is a unit for reading data stored in the CD ROM. The floppy disk drive 109 or the CD ROM drive 110 reads driver software for connecting the image display device 1 and the computer device 50 and the application software for realizing the present invention, which are stored on the floppy disk or in the CD ROM. The software is installed in the hard disk 108. The network connection unit 113 may receive the driver software or the application software, and install it in the hard disk 108.

The keyboard 111 (52a, 52b) is a unit for inputting characters and commands. The input signals of the keyboard 111 are transferred to the operating system or the application software through the low-speed bus 122. The pointing device 112 is a unit for generating a “pointing device signal” (including a “cursor position information signal”, a “pointing device pressing signal”) of the cursors P1 and P2 on the display screens 54a and 54b or the virtual screens 55a and 55b. The “pointing device signal” is transferred to the operating system or the application software through the low-speed bus 122.

The network connection unit 113 is connected to the communication means 60 so as to communicate with the image display device 1. The network connection unit 113 sends the “window image data”, the “window coordinate data”, the “pointing device signal”, the “keyboard signal” and the “screen resolution signal” to the image display device 1 through the communication means 60. The network connection unit 113 receives the “pointing device signal” or the “keyboard signal” sent by another computer device 50 to the image display device 1, from the image display device 1 through the communication means 60. The network connection unit 113 receives the “screen resolution mediation signal” and the “virtual screen movement signal” from the image display device 1 through the communication means 60.

### First Embodiment

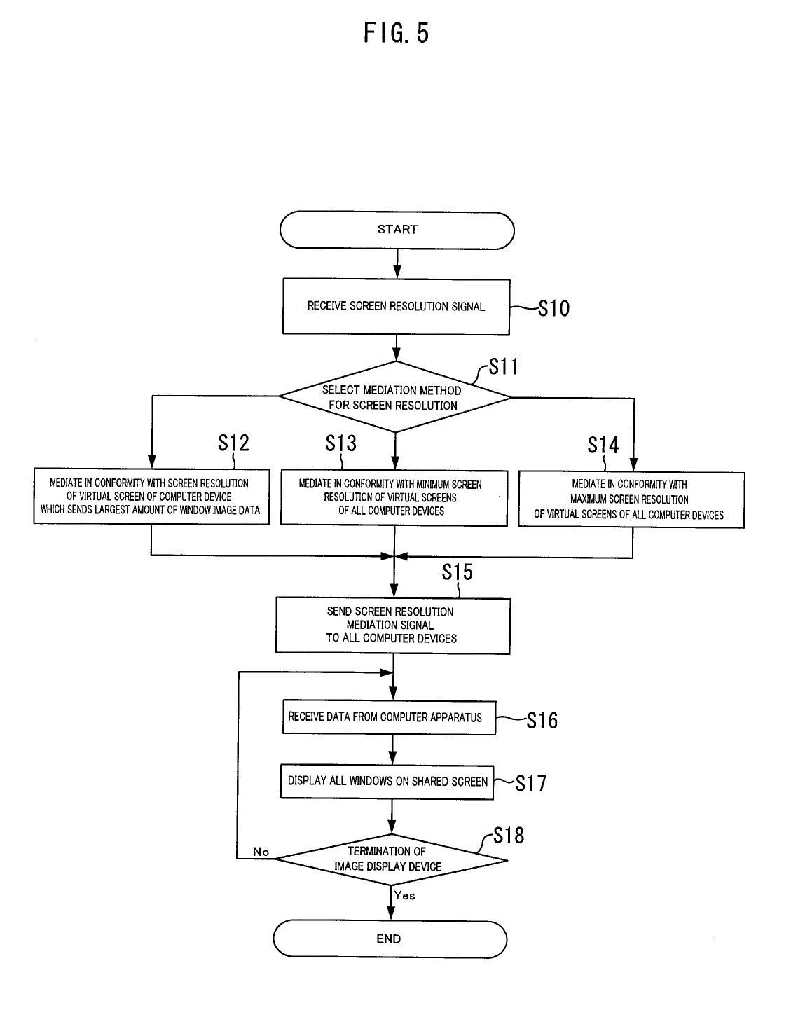

Descriptions will now be made to the first embodiment with reference to FIG. 5. When the image display device 1 is connected to the computer devices 50a and 50b through the communication means 60, the computer devices 50a and 50b send a “screen resolution signal” (an information signal regarding the screen resolution of the virtual screens 50a and 55b) to the image display device 1. Now, the main process of the first embodiment starts, and the image display device 1 proceeds to a process for “receiving a screen resolution signal” in S10.

Table 1 shows the relationship between the screen resolution and the number of pixels.

### [Table 1]

In the process for “receiving the screen resolution signal” in S10, the receiving unit 10a receives the “screen resolution signal” sent by the computer devices 50a and 50b. The “screen resolution signal” is stored in the RAM 13. When the process of S10 ends, the flow proceeds to a process of S11.

In the process for “selecting a screen resolution mediation method” in S11, the user of either one of the computer devices 50a and 50b operates the pointing device 112 or the keyboard 111 to select either one of mediation methods S12 to S14 regarding the screen resolution of the virtual screen 55. The flow proceeds to corresponding one of the process S12 to S14. At this time, the computer device 50 sends user operation information to the image display device 1 through the communication means 60. Note that the user may select either of the mediation methods for the screen resolution S12 to S14, by operating the control panel 36 or remote controller of the image display device 1.

In the process for “performing mediation in conformity with screen resolution of the virtual screen of the computer that sends the largest amount of window image data” in S12, the screen resolution mediation means 14c reads the “screen resolution signal” that is stored in the RAM 13 in the process of S10. Then, the screen resolution mediation means 14c mediates between the screen resolutions of the virtual screens 55a and 55b in conformity with the screen resolution of the virtual screen 55a or 55b of the computer device 50a or 50b that sends the largest amount of “window image data” to the receiving unit 10a. That is, the screen resolution mediation means 14c mediates between the screen resolutions of the virtual screens 55a and 55b in conformity with the screen resolution of the virtual screen 55a or 55b of the computer device 50a or 50b that displays the largest number of “windows” on the shared screen 80. When the process of S12 ends, the flow proceeds to the process of S15.

In the process for “performing mediation in conformity with a minimum screen resolution of virtual screen among all computer devices” in S13, the screen resolution mediation means 14c reads the “screen resolution signal” that is stored in the RAM 13 in the process of S10. The screen resolution mediation means 14c mediates between the screen resolutions of the virtual screens 55a and 55b in conformity with the minimum screen resolution of the virtual screens 55a and 55b of all computer devices 50a and 50b. When the process of S13 ends, the flow proceeds to process of S15.

In the process for “performing mediation in conformity with the maximum screen resolution of the virtual screens of all computer devices” in S14, the screen resolution mediation means 14c reads the “screen resolution signal” that is stored in the RAM 13 in the process of S10. Then, the screen resolution mediation means 14c mediates between the screen resolutions of the virtual screens 55a and 55b in conformity with the maximum screen resolution of the virtual screens 55a and 55b of all computer devices 50a and 50b. When the process of S14 ends, the flow proceeds to the process of S15.

In the process for “sending a screen resolution mediation signal to all computer devices” S15, the screen resolution mediation means 14c generates a “screen resolution mediation signal” based on the screen resolutions of the virtual screens 55a and 55b which are mediated in the processes of S12 to S14, and sends the generated signal to all computer devices 50a and 50b. Upon reception of the “screen resolution mediation signal”, the computer devices 50a and 50b change the screen resolutions of the virtual screens 55a and 55b, based on the received “screen resolution mediation signal”. When the process of S15 ends, the flow proceeds to the process of S16.

In the process for “receiving data from a computer device” in S16, the receiving unit 10a of the image display device 1 receives the “window image data” and “window coordinate data” sent by the computer devices 50a and 50b. The “window image data” and “window coordinate data” are stored in the RAM 13. When the process of S16 ends, the flow proceeds to the process of S17.

In the process for “displaying all windows on the shared screen” in S17, the image arrangement means 14b generates “windows” from the “window image data” and “window coordinate data” stored in the RAM 13, arranges and overlaps the generated windows in one area, and generates “display image data” to be displayed on the shared screen 80. The equal screen resolution is obtained by mediating between the screen resolutions of the virtual screens 55a and 55b of the computer devices 50a and 50b in the process of S15. In this case, if different screen resolutions are obtained between the virtual screens 55a and 55b and the shared screen 80, the image arrangement means 14b increases or decreases the screen resolution by interpolating pixels of the “display image data”, so as to achieve image processing in conformity with the screen resolution of the shared screen 80. Methods for interpolating pixels include a bicubic technique, a bilinear technique, a nearest neighbor technique and the like, but are not limited to these techniques. The “display image data” is stored in the RAM 13. The “display image data” stored in the RAM 13 is output to the image processing circuit 28, and displayed on the screen 75. When the process of S17 ends, the flow proceeds to the determination process of S18.

In the determination for “termination of image processing device” S18, if the user presses an “image display device termination button” of the control panel 36 or the remote controller, the main process of the first embodiment ends. On the contrary, if the user does not press the “image display device termination button” of the control panel 36 or the remote controller, the flow returns to the process of S16.

### Second Embodiment

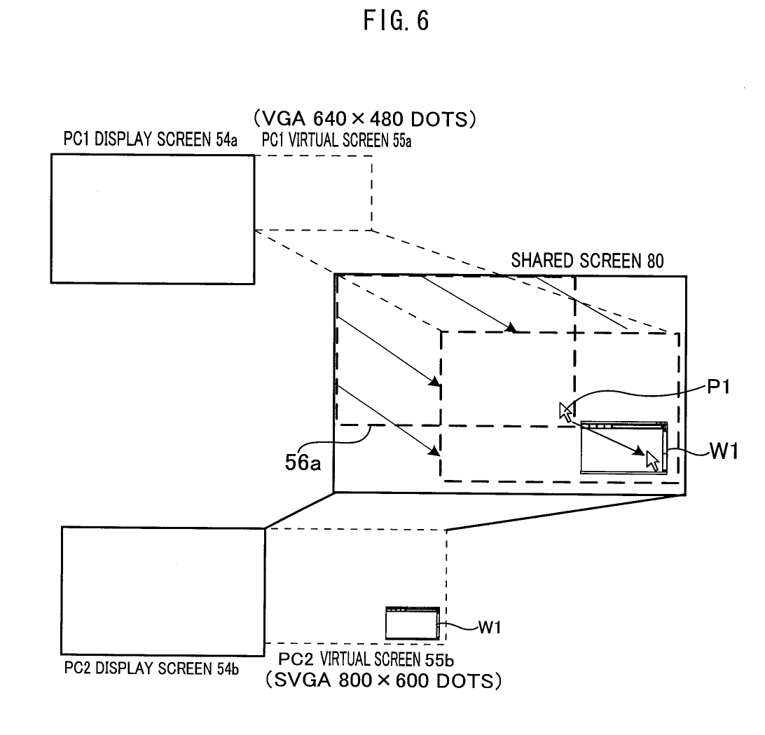

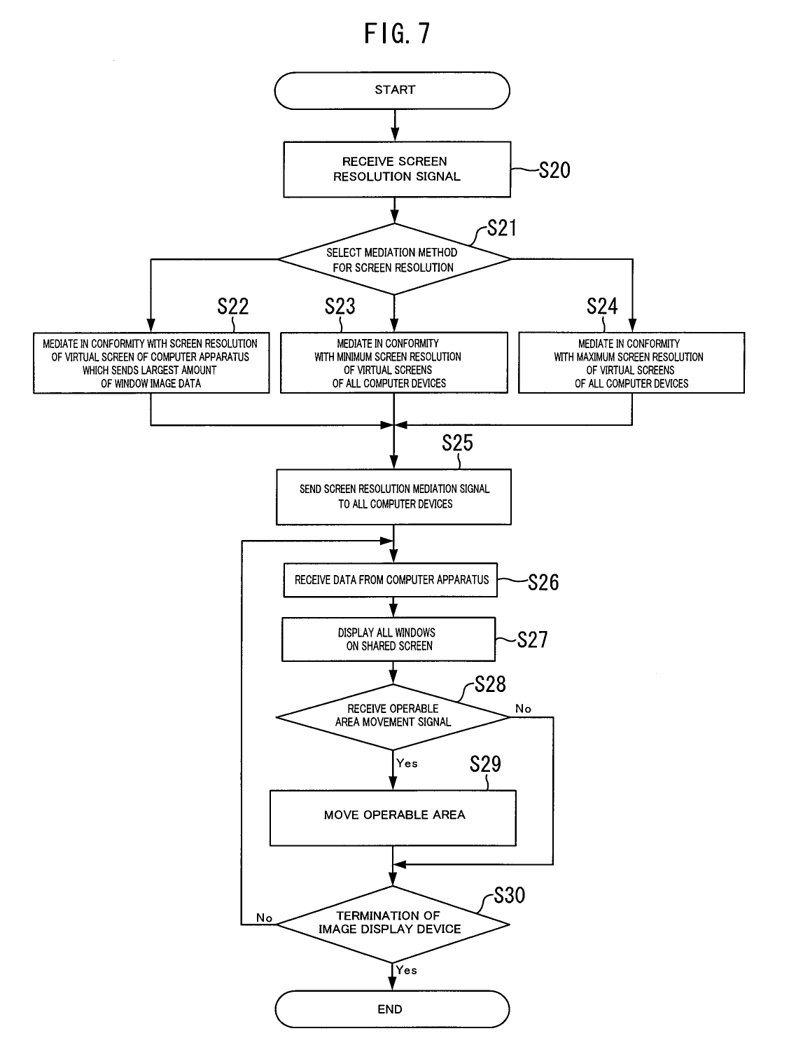

Descriptions will now be made to the second embodiment with reference to FIGS. 6 and 7. If the VRAM of the computer device 50a has only a small capacity, the screen resolution of the virtual screens 55 cannot be changed based on the “screen resolution mediation signal”. Thus, the screen resolutions of the virtual screens 55a and 55b of all computer devices 50a and 50b cannot be mediated. In this case, as shown in FIG. 6, an operable area 56a corresponding to the virtual screen 55a of the computer device 50a does not include all areas of the shared screen 80, and includes a non-operable area. The user 1 of the computer device 50a cannot operate the window W1 of the shared screen 80 outside the operable area 56a. According to the second embodiment, when a non-operable area is generated on the shared screen 80, the operable area 56a on the shared screen 80 is moved upon user operation, thereby enabling operation of the “window” on the shared screen 80.

When the image display device 1 is connected to the computer devices 50a and 50b through the communication means 60, the computer devices 50a and 50b send a “screen resolution signal” (information regarding the screen resolution of the virtual screens 55a and 55b) to the image display device 1. Then, the main process of the second embodiment starts, and the image display device 1 proceeds to the process of S20.

In the process for “receiving a screen resolution signal” in S20, the receiving unit 10a receives the “screen resolution signal” sent by the computer devices 50a and 50b. The “screen resolution signal” is stored in the RAM 13. When the process of S20 ends, the flow proceeds to the process of S21.

In the process for “selecting a screen resolution mediation method” in S21, the user of either one of the computer devices 50a and 50b selects either one of the mediation methods S22 to S24 regarding the screen resolution of the virtual screens 55, by operating the pointing device 112 or the keyboard 111. Then, the flow proceeds to corresponding one of the processes S22 to S24. At this time, the computer device 50 sends the user operation information to the image display device 1 through the communication means 60. Note that the user may select either one of the mediation methods S22 to S24 regarding the screen resolution, by operating the control panel 36 or the remote controller of the image display device 1.

In the process for “performing mediation in conformity with the screen resolution of the virtual screen of the computer device that sends the largest amount of window image data” in S22, the screen resolution mediation means 14c reads the “screen resolution signal” that is stored in the RAM 13 in the process in S20. Then, the screen resolution mediation means 14c mediates between the screen resolutions of the virtual screens 55a and 55b in conformity with the screen resolution of the virtual screen 55a or 55b of the computer device 50a or 50b that sends the largest amount of “window image data” to the receiving unit 10a. That is, the screen resolution mediation means 14c mediates between the screen resolutions of the virtual screen 55a or 55b in conformity with the screen resolution of the virtual screen 55a or 55b of the computer device 50a or 50b that displays the largest number of “windows” on the shared screen 80. When the process of S22 ends, the flow proceeds to the process of S25.

In the process for “performing mediation in conformity with the minimum screen resolution of the virtual screen of all computer devices” in S23, the screen resolution mediation means 14c reads the “screen resolution signal” that is stored in the RAM 13 in the process of S20. Then, the screen resolution mediation means 14c mediates between the screen resolutions of the virtual screens 55a and 55b in conformity with the minimum screen resolution of the virtual screen 55a or 55b of all computer devices 50a and 50b. When the process of S23 ends, the flow proceeds to the process of S25.

In the process for “performing mediation in conformity with the maximum screen resolution of the virtual screens of all computer devices” in S24, the screen resolution mediation means 14c reads the “screen resolution signal” that is stored in the RAM 13 in S20. Then, the screen resolution mediation means 14c mediates between the screen resolutions of the virtual screens 55a and 55b in conformity with the maximum screen resolution of the virtual screens 55a and 55b of all computer devices 50a and 50b. When the process of S24 ends, the flow proceeds to the process of S25.

In the process for “sending a screen resolution mediation signal to all computer devices” in S25, the screen resolution mediation means 14c generates a “screen resolution mediation signal”, based on the screen resolutions of the virtual screens 55a and 55b that are mediated in the processes S22 to S24, and sends the generated signal to all computer devices 50a and 50b. If the VRAM of the computer devices 50a and 50b has sufficient capacity for changing the screen resolution to the one that has been mediated in the processes of S22 to S24, the computer devices 50a and 50b that have received the “screen resolution mediation signal” change the screen resolutions of the virtual screens 55a and 55b, based on the received “screen resolution mediation signal”. On the contrary, the VRAM of either one of the computer devices 50a and 50b may have insufficient capacity, and the VRAM does not have sufficient capacity for changing the screen resolution to the one that has been mediated in the process S22 or S24. In this case, the computer devices 50a and 50b that have received the “screen resolution mediation signal” change the screen resolutions of the virtual screens 55a and 55b to the maximum changeable screen resolution. When the process of S25 ends, the flow proceeds to the process for “receiving data from a computer device” in S26.

In the process for “receiving data from a computer device” in S26, the receiving unit 10a of the image display device 1 receives the “window image data” and the “window coordinate data” sent by the computer devices 50a and 50b. The “window image data” and the “window coordinate data” are stored in the RAM 13. When the process of S26 ends, the flow proceeds to the process of S27.

In the process for “displaying all windows on the shared screen” in S27, the image arrangement means 14b generates “windows” from the “window image data” or the “window coordinate data” that are stored in the RAM 13. Then, the image arrangement means 14b arranges and overlaps the windows in one area, and generates “display image data” to be displayed on the shared screen 80. The “display image data” is stored in the RAM 13.

The “display image data” stored in the RAM 13 is output to the image processing circuit 28, and is displayed on the screen 75. When the process of S27 ends, the flow proceeds to the determination process of S28.

In the determination process for “receiving an operable area movement signal” in S28, it may be determined that the receiving unit 10a has received the “operable area movement signal” from the computer devices 50a and 50b. In this case, the received “operable area movement signal” is stored in the RAM 13, and the flow proceeds to the process of S29. On the contrary, the receiving unit 10a has not received the “operable area movement signal” from the computer devices 50a and 50b, the flow proceeds to the determination process for “termination of image display device”. The “operable area movement signal” is generated by the user 1 operating the pointing device 112 or the keyboard 111 of the computer device 50a, when a non-operable area is generated on the shared screen 80. Then, the generated signal is sent to the receiving unit 10a of the image display device 1 through the communication means 60.

In the process for “moving an operable area” in S29, the operable area movement means 14d reads the “operable area movement signal” that is stored in the RAM 13 in accordance with the determination of S28. The operable area movement means 14d moves the operable area 56a on the shared screen 80. For example, as shown in FIG. 6, the user 1 of the computer device 50a moves the cursor P1 on the operable area 56a to the boundary of the operable area 56a by operating the pointing device 112. In response to this, the operable area 56a moves and follows the cursor P1, thereby enabling operation of the window W1. The operable area 56a on the shared screen 80 may be moved also using an arrow button of the keyboard 11. When the process of S29 ends, the flow proceeds to the determination process of S30.

In the determination process for “termination of image processing device” in S30, if the user presses the “image display device termination button” of the control panel 36 or the remote controller, the flow of the second embodiment ends. On the contrary, if the user does not press the “image display device termination button” of the control panel 36 or remote controller, the flow returns to the process of S26.

According to the first or second embodiments, in the selection in S11 or S21, the user selects the mediation method for the screen resolution of the virtual screens 55a and 55b. However, the present invention is not limited to these embodiments, and may include an embodiment in which is set a mediation method for the screen resolution of the virtual screens 55a and 55b in advance.

The present invention has been described with the example using the projector, by way of one example of the image display device 1. The image display device of the present invention is not limited to the projector. Needless to say, the present invention is applicable to any image display, such as a cathode-ray tube, a liquid crystal display, an organic EL display, a plasma display, a rear-projection display, etc.

Accordingly, the present invention has been described in connection with the most practical and preferable embodiments at present. However, the present invention is not limited to the embodiments disclosed in this specification. Various changes can suitably be made without departing from the scope of the present invention as described in the appended claims and the specification. It should be comprehended that an image display device and an image display system with such changes are included in the technical scope of the present invention.

TABLE 1

| SCREEN RESOLUTION | NUMBER OF PIXELS |
|---|---|
| VGA | 640 × 480 PIXEL |
| SVGA | 800 × 600 PIXEL |
| XGA | 1024 × 768 PIXEL |
| WXGA | 1280 × 768 PIXEL |
| SXGA | 1280 × 1024 PIXEL |
| SXGA+ | 1400 × 1050 PIXEL |

What is claimed is:

1. An image display device for displaying windows on virtual screens adjacently provided to display screens of a plurality of computer devices on a shared screen as one area, thereby enabling users of the plurality of computer devices to operate the windows displayed on the shared screen, the device comprising:
a receiving unit which receives window image data as image data of the windows on the virtual screens and screen resolution signals of the virtual screens, from the plurality of computer devices;
an image arrangement means which generates the windows from the received window image data, and arranges to overlap the windows on the shared screen; and
a screen resolution mediation means which, when it is determined, based on the screen resolution signals received by the receiving unit, that screen resolutions of the virtual screens of the plurality of computer devices differ from each other, sends a screen resolution mediation signal for mediating between the screen resolutions of the virtual screens to the plurality of computer devices, wherein
the computer devices receive the mediation signal so as to mediate between the resolutions of the virtual screens.

2. The image display device according to claim 1, wherein
the screen resolution mediation means mediates between the screen resolutions in conformity with a minimum screen resolution, of the screen resolutions of all the computer devices.

3. The image display device according to claim 1, wherein
the screen resolution mediation means mediates between the screen resolutions in conformity with a maximum screen resolution, of the screen resolutions of all the computer devices.

4. The image display device according to claim 1, wherein
the screen resolution mediation means mediates between the screen resolutions in conformity with a most common screen resolution, of the screen resolutions of the virtual screens of the computer devices that send the window image data to the receiving unit.

5. The image display device according to claim 1, wherein
the screen resolution mediation means mediates between the screen resolutions of the virtual screens, when the plurality of computer devices is connected with the image display device.

6. The image display device according to claim 1, further comprising an operable area movement means which:
receives, by the receiving unit, an operable area movement signal which is generated in response to an operation of a user of a computer device with an area not operable on the shared screen, when the screen resolutions of the virtual screens of all computer devices have not successfully been mediated upon transmission of the screen resolution mediation signal to the plurality of computer devices by the screen resolution mediation means; and
moves an operable area on the shared screen based on the operable area movement signal.

7. An image display system comprising:
a plurality of computer devices which send window image data as image data of windows on virtual screens provided adjacent to respective display screens and screen resolution signals of the virtual screens;
an image display device which
receives the window image data and the screen resolution signals of the virtual screens sent from the computer devices,
generates windows from the window image data,
arranges and displays the generated windows by overlapping on a shared screen as one area, and
sends screen resolution mediation signals for mediating between the screen resolutions of the virtual screens to the plurality of computer devices, when it is determined, based on the screen resolution signals, that the virtual screens of the plurality of computer devices have different screen resolutions; and
a communication means which allows communication between the computer devices and the image display device, wherein
the plurality of computer devices which have received the screen resolution mediation signals from the image display device change the screen resolutions of the virtual screens, based on the screen resolution mediation signals.

8. The image display system according to claim 7, wherein
the computer devices send, to the image display device, an operable area movement signal which is generated in response to an operation of a user of the computer device with an area not operable on the shared screen, when the screen resolutions of the virtual screens of the plurality of computer devices have not successfully been mediated upon transmission of the screen resolution mediation signals to the plurality of computer devices by the image display device, and
the image display device which has received the operable area movement signal moves an operable area on the shared screen based on the operable area movement signal.
